(19) United States
(12) Patent Application Publication
(10) Pub. No.: US 2017/0165829 A1
(43) Pub. Date: Jun. 15, 2017

(54) Inserts for an Assortment Box

(71) Applicant: Raaco A/S, Nykøbing F (DK)

(72) Inventor: Peter-Thomas DAMBERG, Nykøbing Falster (DK)

(21) Appl. No.: 15/324,440

(22) PCT Filed: Jul. 9, 2015
(86) PCT No.: PCT/EP2015/065720

§ 371 Date: Jan. 6, 2017

(30) Foreign Application Priority Data
Jul. 9, 2014 (EP) 14176310.2

(51) Int. Cl. B25H 3/02; B65D 25/28; B65D 43/22; B65D 25/10; B65D 43/16

(52) U.S. Cl. CPC B25H 3/021; B65D 25/10; B65D 43/16; B65D 43/22; B65D 25/28

(57) ABSTRACT

The present invention relates to a container, such as an assortment box, comprising a storage assembly, wherein said storage assembly is for storing contents inside said container, said storage assembly comprising at least one storage unit and a reception layer, wherein said at least one storage unit is adapted to be connected to said reception layer in a releasable manner by use of a first connection means.

The present invention relates to a container, such as an assortment box, comprising a storage assembly, wherein said storage assembly is for storing contents inside said container.

For example, when doing carpentry or installing items, such as lamps, in your house, it is well known to make use of a toolbox or an assortment box, containing e.g. screws, nails and bolts. Depending e.g. on whether you work professionally or you just install items in your spare time, and depending on the variety of e.g. screws, nails and bolts to be used, the user may have to spent a lot of time finding the correct part in the toolbox or assortment box.

To remedy the above disadvantage, various variants of toolboxes or assortment boxes have been proposed. Known solutions for reducing the difficulty in finding the correct part in the toolbox or assortment box include insertion of several small storage units in the toolbox or assortment box, e.g. one for each type of part, and one for each size of part. However, when for example the user is doing carpentry or installing items, the toolbox or assortment box may obviously be open and e.g. have been placed on the floor. By accident, the toolbox or assortment box may be overlooked and get a kick or push, and the small storage units with contents may fly out of the toolbox or assortment box. Furthermore, if the user changes his mind about what and how much is to be contained in the toolbox or assortment box, the user needs the possibility of e.g. amending the size and arrangement of the small storage units in an easy way which is not possible if the small storage units have been permanently fixed to the tool box or assortment box.

DE 9202843 U1 relates to an assortment box comprising small quadratic storage units to comprise screws and similar. The storage units are meant to be replaceable storage units for one time use. Thus, the storage units are made of cardboard which may be opened and inserted into the assortment box. However, DE 9202843 U1 does not provide a way to prevent the storage units from flying out of the toolbox or assortment box if the box is e.g. kicked.

U.S. 2006/070900 A1 relates to tool container including a first and second container member rotatably connected to create an inner compartment. Each member has a compartment outer wall and integrally formed perimeter walls. A grid system is created on an inner compartment facing surface adjacent at least one of the compartment outer walls. The grid system includes female receptacles arranged in each of a plurality of rows and columns. Tool packages having at least one male peg member are releasably engaged within selected receptacles providing multiple locations and orientations about the grid system for the tool packages.

GB 2482126 A relates to a container comprising a housing, a lid for releasably closing the housing and releasable locking means for releasably securing the lid in a closed condition. The locking means comprises a lid locking member displaceable between a locked position which inhibits the lid, when closed, from being opened and an unlocked position which permits the lid to be opened and closed, and retaining means actuated by displacement of the locking member to one of the unlocked and locked positions to retain the locking member in that position and to inhibit displacement to the other position. Several of the containers may be fitted in a larger outer container and may be releasably retained within the outer container by interengaging retaining means on the smaller and larger containers.

Known containers, such as toolboxes or assortment boxes, do not provide a way of allowing the user to rearrange the storage units and at the same time prevent the storage units from falling out of the container by accident.

In accordance with the invention, there is provided a container, such as an assortment box, comprising a storage assembly, wherein said storage assembly is for storing contents inside said container, said storage assembly comprising at least one storage unit and a reception layer fixated inside said container, wherein said at least one storage unit is adapted to be connected to said reception layer in a releasable manner by use of a first connection means.

When making use of a container, such as an assortment box or a toolbox, and several different parts, such as screws of different sizes, it may obviously be an advantage that the container comprises some sort of storage assembly so that the user may store the different parts inside the container in an assorted way. This way, the user has a possibility of finding the wanted part relatively quickly.

When making use of a storage assembly, which comprises at least one storage unit and a reception layer, where the storage unit is adapted to be connected to the reception layer, said storage unit may be held by the reception layer via the first connection means and thus be prevented from moving around unintentionally inside said container. Furthermore, by having the reception layer fixated inside said container, the reception layer cannot move substantially relative to said container which could be the case if the container gets a kick by accident. By fixated is meant that the reception layer is completely fixed inside said container and cannot move relative to the container, or that the reception layer can move only limited relative to the container. Thus, the user always knows where the storage unit(s) and the reception layer are located inside the container and will know that the storage unit(s) and/or reception layer has/have not been expelled completely from said container as they will not move relative to each other and to the container unintentionally.

The fact that the at least one storage unit is adapted to be connected to the reception layer in a releasable manner reduces the difficulty of using the storage assembly and reduces the expenses. This means that the user may want to rearrange the storage unit(s) relative to the reception layer, or if more than one storage unit is connected to the reception layer, the user may want to rearrange the storage units relative to each other e.g. to adapt to the number of different parts. It follows that if the storage units are to be placed differently relative to each other, the same container, reception layer and storage containers may be used as the storage units are connected in a releasable manner. There is no need for buying a new type of container.

Thus, the present invention provides a container and a storage assembly which may be adjusted and which minimises the expenses.

In an embodiment, said first connection means can comprise at least one releasable snap engagement. The releasable snap engagement may comprise two slots in the reception layer and two taps on the storage unit, where the taps may have the shape of a hook, i.e. have a straight body and a head at the end of the body, said head protruding away from the end of the body in a direction orthogonal to the extension of the body. The taps may be slightly misaligned with the slots, when the taps are placed adjacent to each their slot, and are thus ready to be connected. Thus, when the taps meet their respective slot, the user needs to press the storage unit towards the reception layer, whereby the taps are bent in a direction towards the slots, and the taps including the heads become aligned with the slots and thus engage with the slots. The slots may become wider below their opening so that the taps may bend back towards their original position relative to the storage unit after the taps including head have passed the opening of the slots, i.e. the taps may snap-engage with the slots. Thus, the taps may show an elastic behaviour. The storage unit cannot be easily removed from the reception layer. To remove the storage unit from the reception layer, the user has to pull the storage unit. Thereby, the taps including their heads bend and thus align with the opening of the slots, whereby the engagement between the taps and the slots disengage. However, other types of releasable snap engagements are foreseen within the scope of the present invention.

Making use of a releasable snap engagement results in the storage unit(s) being easy to connect to the reception layer and to remove again. The user simply has to align the first connection means of the storage unit and the reception layer relative to each other and press the storage unit towards the reception layer so that the storage unit and reception layer snap-engage. When removing or relocating a storage unit(s), the user simply has to pull the storage unit, whereby the snap engagement releases.

Snap engagements are easy to operate and are reliable as the operation only comprises few simple steps, such as bending a tap. Furthermore, part of the engagement means, e.g. a tap, may be either produced as part of the storage unit or mounted on the storage unit after production. If the storage unit is produced in e.g. a plastic material, it may be an advantage that at least part of the engagement means is produced as part of the storage unit to reduce the number of steps in the production.

In an embodiment, said first connection means can comprise at least one protruding part and one recess part. Having at least one protruding and one recess part means that it is easy for the user to orientate the storage unit correctly relative to the reception layer, i.e. each protruding part simply has to be aligned with a recess part. Furthermore, applying a protruding and a recess part, such as a rod/tap/feet and a hole, respectively, results in the method of connecting being easy, reliable and stable, and in the wear in the first connection means being minimal.

Providing not only snap engagement, but also at least one protruding part and one recess part, facilitates that the storage units may be easy to align and connect with the reception layer, i.e. by aligning protruding with recess parts, and then pressing the storage unit towards the reception layer so that the snap engagement engages.

Some storage units may comprise both at least one protruding part and one recess part and at least one releasable snap engagement, while others may only comprise at least one protruding part and one recess part. Thus, the storage units may be arranged on the reception layer so that the storage units comprising items, which the user most likely needs several of at a time, may not comprise releasable snap engagement so that the user may easily remove such a storage unit from the container and carry it somewhere else. Storage units, which the user does not need to carry somewhere else may comprise first connection means comprising at least one snap engagement. Thus, at least some of the storage units may be engaged with the reception layer and some may not.

Thus, the present invention provides a simple way of connecting storage units and reception layer and provides the user with a possibility of amending the mutual arrangement between the storage units and the reception layer.

In an embodiment, said storage unit can comprise the at least one protruding part, and said reception layer can comprise the at least one recess part adapted to receive the at least one protruding part. Having the storage unit comprise the at least one protruding part and the reception layer comprise the at least one recess part may mean that the reception layer may also be adapted to receive storage units which do not comprise connection means, i.e. storage units originally meant to be used in another type or version of container. Thus, comprising recess part(s) in the reception layer means that there are no part(s) protruding from the reception layer which might prevent a storage unit without connection means from resting on the reception layer. Storage units without at least part of the first connection means may be sufficient if the user wants to carry the storage unit away, once the container has been opened.

In an embodiment, the first connection means can be arranged at the reception layer and at a lower surface of the at least one storage unit. Having the first connection means arranged at the reception layer, e.g. uniformly distributed on the surface of the reception layer, and at the lower surface of the at least one storage unit may have the result that the storage unit(s), when connected to the reception layer, may be installed in an upright position with its/their opening directed towards the opening of the container. Furthermore, the connection of the storage unit to the reception layer is easy as the user only has to focus on connection means arranged at one surface of the storage unit and on the reception layer.

In an embodiment, the reception layer can be adapted to be fixated with an inner part of the container in a releasable manner by use of a second connection means. The inner part of the container may be the bottom of the container so that the reception layer forms an extra bottom on top of the existing bottom of the container when connected to the container. Thus, the reception layer may be planar, but other shapes, such as levelled, are foreseen within the present invention. The second connection means may comprise a releasable snap engagement to facilitate easy installation of the reception layer. Thus, the user only has to align the reception layer relative to the inner part of the container and press to fixate/connect/engage with said inner part. However, other types of connection means are foreseen within the present invention.

If the reception layer is a separate layer that may fixate/connect with the inner part of the container, the user has the choice of installing the reception layer if wanted/needed, i.e. it is not a requirement, but a choice.

Providing the reception layer as a separate layer facilitates that the reception layer may be installed in containers already existing on the marked. Furthermore, various types of reception layers, i.e. with varying distribution of at least part of the first connection means, e.g. the recess part, may thus be installed in the container so that the reception layer may be chosen according to the intended use and content of the container.

Thus, the present invention provides a user-friendly container and provides the user with the possibility of amending the container according to the intended use.

In an embodiment, a bottom of the container can be the reception layer. Providing the reception layer as a bottom of the container may have the advantage that the user does not have to worry about installing the reception layer, ie. how to align the reception layer relative to an inner part of the container and afterwards pressing it towards the inner part to secure it to the inner part as it has already been installed. This also has the result that the reception layer may be incorporated in the production of the container and does not have to be produced in a separate production and installed in the container afterwards. Thus, the production may be simpler and less expensive.

In an embodiment, at least part of the first connection means can be arranged symmetrically on the lower surface of the at least one storage unit relative to a plane which is parallel with and intersects the longitudinal axis of said at least one storage unit and which is orthogonal with at least one side of said at least one storage unit. Providing first connection means, which are arranged symmetrically on said lower surface, may be a help for the user in aligning the at least one storage unit relative to the reception layer so that said storage unit and said reception layer may be connected. This means that it may be easy to identify/locate where the first connection means is placed on the lower surface of the at least one storage unit and on the reception layer as it is placed symmetrically at the lower side of said storage unit which may be at the corners of said lower surface. Furthermore, arranging the first connection means symmetrically may result in the connection being more stable, i.e. that the connection prevents the at least one storage unit from rocking or from being otherwise unstable on the reception layer.

In an embodiment, the reception layer can be adapted to connect with more than one storage unit at a time. As explained previously, when e.g. doing carpentry or installing items, such as lamps, in your house, it is well known to make use of a toolbox or an assortment box containing e.g. screws, nails, bolts, electronic components, tool components, bits, small tool devices etc. Depending e.g. on whether you work professionally or you just install items in your spare time and depending on the variety of e.g. screws, nails and bolts to be used, the user may have to spent a lot of time finding the correct part in the toolbox or assortment box for which reason it may be an advantage to install not only one, but several storage units in the container. This way the user may store and arrange the parts in the container in an easy and reliable way.

In an embodiment, the at least one storage unit can be arranged adjacent to one or further storage units when connected with said reception layer. Arranging the at least one storage unit adjacent to one or further storage units may result in the storage units being arranged side by side touching or almost touching each other when connected with said reception layer. Thus, the storage units may be closely packed on the reception layer and this way, the highest possible number of storage units may be arranged on the reception layer.

Furthermore, arranging the at least one storage unit adjacent to one or further storage units makes it easier for the user to install said storage units on the reception layer, i.e. to identify where exactly on the reception layer said storage units may be connected as the user simply has to align a storage unit next to/adjacent to the storage unit(s) already connected to the reception layer and move it towards the reception layer for obtaining connection.

In an embodiment, the at least one storage unit can comprise straight walls being orthogonal to the lower surface of the at least one storage unit. Providing straight walls further facilitates that the at least one storage unit may be arranged adjacent to one or further storage units, and thus that the storage units may be closely packed on the reception layer as the sides of adjacently placed storage units may be parallel to each other. Thus, minimal free space exists between the storage units when installed in the container thus providing maximal storage volume in the inside of the container. The shape of the storage units may be cubic, rectangular cuboid, square cuboid or many sided, but other shapes are also foreseen within the present invention.

In an embodiment, a limited section of the reception layer may not comprise at least part of the first connection means. A limited section of the reception layer may e.g. be half of the surface of the reception layer, or a square or rectangular region of said surface or alternatively, have a shape according to the part(s) to be stored in that section. Providing a limited section of the reception layer without at least part of the first connection means, e.g. recesses or slots, may be an advantage if the container is meant to contain a limited amount and limited variety of parts, such as nails, screws, bolts, electronic components etc., and the remaining volume of the container has to contain large parts, such as e.g. tools. Thus, there is no need for the reception layer to comprise first connections means on the limited section.

In accordance with the invention, there is provided a reception layer for a container, said reception layer being adapted to connect to a container and to at least one storage unit in a releasable manner by use of connection means.

In accordance with the invention, there is provided a storage unit for a container, said storage unit comprising a bottom and at least one side part, said bottom and at least one side part defining an inner volume of said storage unit, and wherein said storage unit is adapted to connect to a reception layer in a releasable manner by use of a connection means.

The structure and function of the container, storage unit and reception layer, and the method of using them will be described in more detail below with references to exemplary embodiments shown in the drawings wherein,

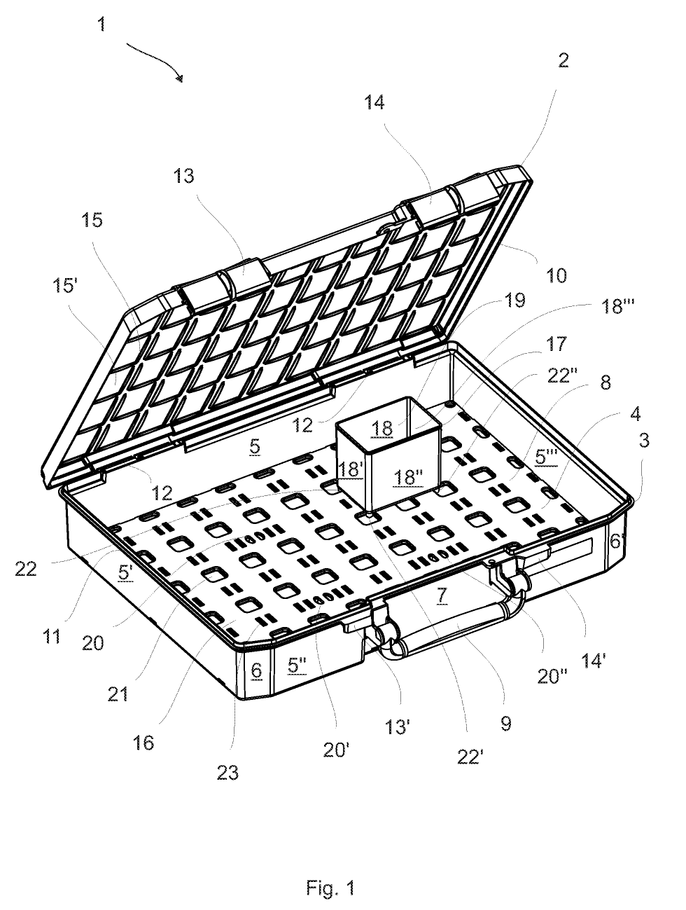

FIG. 1 shows one embodiment of a container with a reception layer connected to the inner part of the container and with a storage unit connected to the reception layer, seen in a perspective view.

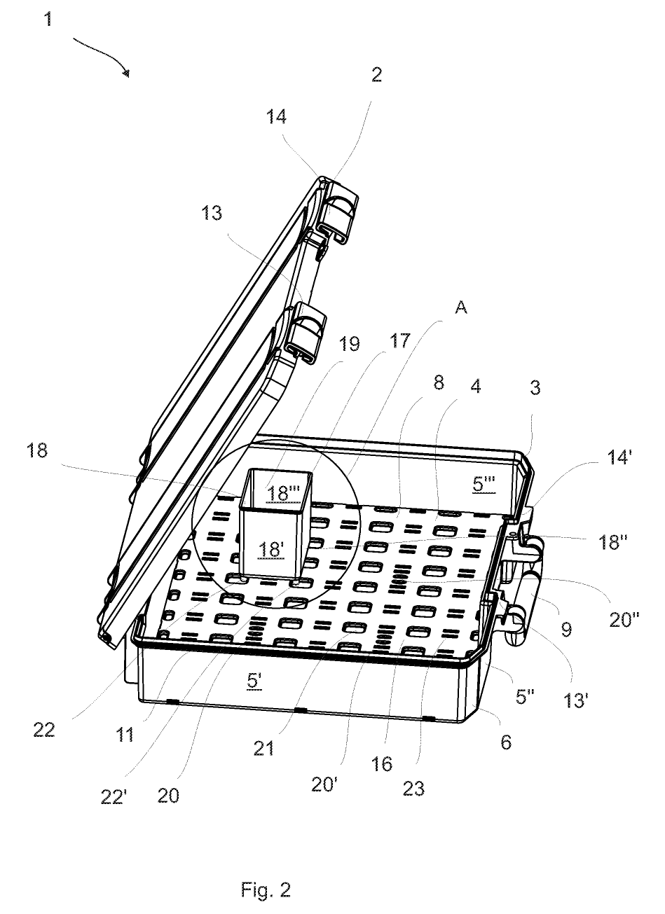

FIG. 2 shows one embodiment of a container with a reception layer connected to the inner part of the container and with a storage unit connected to the reception layer, seen in a perspective view from the side.

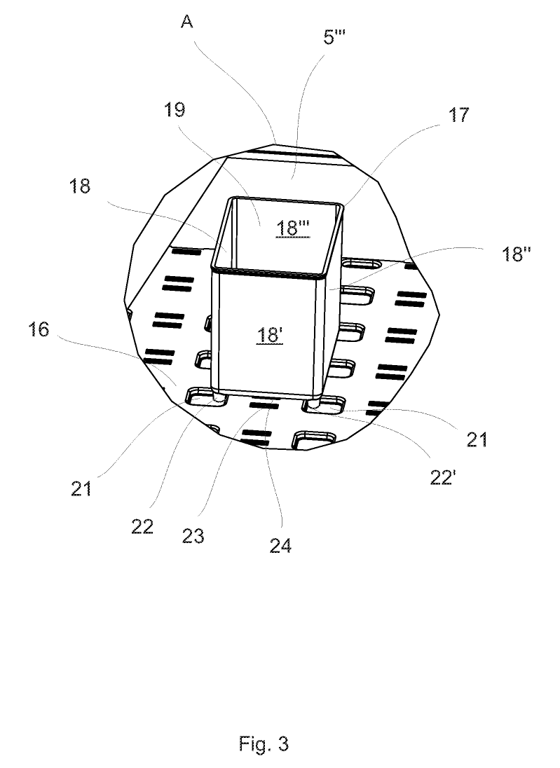

FIG. 3 shows a fragmentary view of one embodiment, where the storage unit is connected to the reception layer.

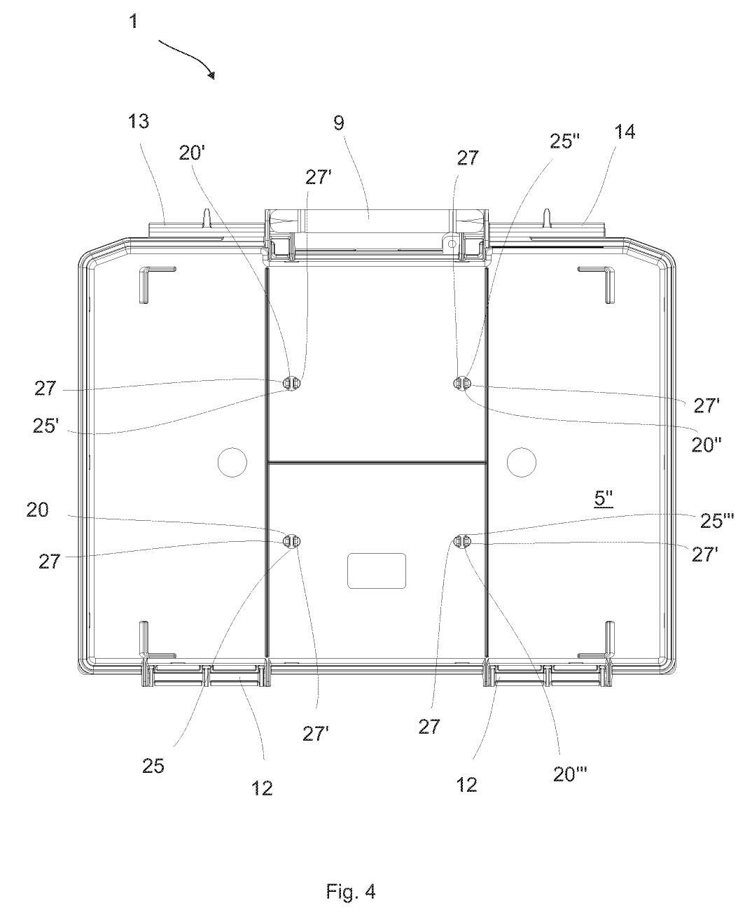

FIG. 4 shows one embodiment of the container seen from below, where a reception layer in connected to an inner part of the container.

In the figures, the container, the storage unit and the reception layer are shown having a rectangular cross section. However, it should be understood that other cross sections, such as circular, oval, square etc., are also intended within the scope of the present invention.

In the figures, the embodiments illustrate that the storage assembly may be for a toolbox or an assortment box. The person skilled in the art will understand that the illustrated combination of storage assembly and container is not to be understood as exhaustive and that one kind of storage assembly may be used with several kinds of containers, and one kind of storage unit may be used with several kinds of reception layers, and that the storage units may contain various types of contents, such as tools, nails, screws, spare parts, electronic components, groceries, tool components, bits, small tool devices etc.

FIG. 1 shows one embodiment of a container with a reception layer connected to the inner part of the container and with a storage unit connected to the reception layer, seen in a perspective view.

In the exemplary embodiment, the container 1 is seen with an upper lid part 2 separated from a lower container part 3.

The lower container part 3 is seen to have a substantially rectangular cross section and comprises a bottom part 4 and a first 5, second 5′, third 5″, and fourth side part 5″′ being substantially orthogonal to each other and to the bottom part 4. The third side part 5″ comprises two angled ends 6,6′ and a central part 7 projecting into the inner opening 8 of the lower container part 3 thus defining a recess in the third side part 5″ arranged for comprising a handle 9 for the container 1.

The periphery of the cross section of the upper lid part 2 is seen to have substantially similar shape and size as the periphery of the cross section of the lower container part 3 such that an inner edge 10 of the upper lid part 2 can engage with an upper edge 11 of the lower container part 3 when the upper lid part 2 closes the opening of the lower container part 3. The upper lid part 2 may be pivotally connected to the lower container part 3 by use of a pivotal connection 12, such as hinges 12. When the container 1 is closed, i.e. the lower container part 3 and the upper lid part 2 engage with each other, the container 1 may be locked by use of a first and second locking unit. Each of the locking units comprises a sliding part 13,14 and a holding part 13′,14′. The sliding parts 13,14 may be slid over each their respective holding part 13′,14′ when the container 1 has been closed. Thus, the container 1 has been locked, and the lower container part 3 and upper lid part 2 cannot be separated before the first and second locking units have been unlocked again. Thus, the user can now pick up the container 1 by the handle 9 and transport the container 1 without any risk of the contents of the container 1 falling out.

In the exemplary embodiment of FIG. 1, the upper lid part 2 may comprise a transparent material so that the content in the inner opening 8 of the container 1 may be seen both when the container 1 is open and closed.

The inner surface 15 of the upper lid part 2 may comprise several small areas 15′, so called U-profiles 15′, each of which bends slightly out from the upper lid part 2.

In the exemplary embodiment of FIG. 1, a reception layer 16 has been connected with an inner part, i.e. the bottom 4, of the container 1 in a releasable manner by use of a second connection means. A storage unit 17 has been connected to the reception layer 16 in a releasable manner by use of a first connection means. Together, the at least one storage unit 17 and the reception layer 16 form a storage assembly for storing contents inside said container 1. The reception layer 16 may have a planar shape and may fill the entire bottom of the container 1, but other shapes and sizes of the reception layer 16, such as where the reception layer 16 fills e.g. the major part or half of the bottom of the container 1, are foreseen within the present invention.

The storage unit 17 may comprise a first 18, second 18′, third 18″ and fourth side wall 18″′ and a lower surface (not shown), where said side walls 18,18′,18″,18″′ are all orthogonal to each other and to the lower surface and together define an inner volume 19 of the storage unit 17. The opening of the storage unit 17 may be directed towards the upper lid part 2 and thus towards the opening of the container 1, and parts such as nails, screws, bolts or electronic components, may be introduced into or removed from the inner volume 19 via the opening. When the upper lid part 2 engages the lower container part 3, the upper lid part 2 and thus part of the U-profiles 15′ come in close contact with the opening of the storage unit 17 which means that the parts contained in the storage unit 17 will not escape the storage unit 17 even if the container 1 is moved around.

The reception layer 16 has been connected with the inner part of the container 1 by use of a second connection means in the embodiment of FIG. 1 illustrated by a first 20, second 20′, third 20″ and fourth snap engagement (not shown). The reception layer 16 may comprise at least one recess part 21 for receiving at least one protruding part of the storage unit 17. In the embodiment of FIG. 1, the storage unit 17 comprises a first 22, second 22′, third 22″ and fourth protruding part (not shown), such as feet of the storage unit 17. The reception layer 16 is also shown to comprise at least one slot 23 adapted to receive a first 24 and second tap 24′ of a snap engagement (not shown) of the storage unit 17. Providing a first connection means for connecting the reception layer 16 and at least one storage unit 17 facilitates that the at least one storage unit 17 does not fall out of the inner opening 8 of the lower container part 3 in case the container 1 is e.g. kicked by accident.

As the reception layer 16 may be connected with the inner part of the container 1 by use of a second connection means, the user has the possibility of installing the reception layer 16 in the container 1 if wanted, but may also remove it if there is no need to have a storage assembly in the container 1. The user may also install the type of reception layer 16 that is appropriate for the purpose. For example, if various parts are to be stored, then a reception layer 16, which may connect to several storage units 17 as shown in FIG. 1, may be installed. On the other hand, if the user only needs to have storage units 17 for a limited number of parts, then a reception layer 16, where a limited section of the reception layer 16 does not comprise at least part of the connection means, may be installed. Then, e.g. a tool may be stored in the inner volume of the container 1 defined by said limited section.

FIG. 2 shows one embodiment of a container 1 with a reception layer 16 connected to the inner part of the container 1 and with a storage unit 17 connected to the reception layer 16, seen in a perspective view from the side. For similar parts, similar reference numbers have been used as in FIG. 1.

In the exemplary embodiment, the container 1 is seen with an upper lid part 2 separated from a lower container part 3.

A reception layer 16 has been connected to an inner part of the container 1 in a releasable manner. At least one storage unit 17 has been connected to the reception layer 16 in a releasable manner. The user may now fill parts into the inner volume 19 of the storage unit 17 and may connect more storage units 17 to the reception layer 16.

FIG. 3 shows a fragmentary view of one embodiment, where the storage unit 17 is connected to the reception layer 16. For similar parts, similar reference numbers have been used as in the previous FIGS.

The storage unit 17 has been connected to the reception layer 16. The storage unit 17 may have a shape of a rectangular cuboid comprising a first 18, second 18′, third 18″ and fourth side wall 18″′ and a lower surface (not shown), where all said side walls 18,18′,18″,18″′ are orthogonal to each other and to the lower surface and together define an inner volume 19 of the storage unit 17. Other shapes are foreseen within the present invention. A first 22, second 22′, third 22 (not shown) and fourth protruding part (not shown) is each received by a recess part 21 of the reception layer 16.

The reception layer 16 may also comprise at least one slot 23 adapted to receive a first 24 and second tap 24′ of the snap engagement (not shown) of the storage unit 17. The snap engagement facilitates that the at least one storage unit 17 does not fall out of the inner opening 8 of the lower container part 3 in case the container 1 is e.g. kicked by accident.

In the exemplary embodiment of FIG. 3, the releasable snap engagement comprises a first 24 and second tap 24′ (not shown) on the storage unit 17, where the taps 24,24′ may have the shape of a hook, i.e. have a straight body and a head at the end of the body that protrudes away from the end of the body in a direction orthogonal to the extension of the body. The taps 24,24′ may be slightly misaligned with the slots 23 when the taps 24,24′ are placed adjacent to each their slot 23 and are thus ready to be connected. Thus, when the taps 24,24′ meet their respective slot 23, the user needs to press the storage unit towards the reception layer 4, whereby the taps 24,24′ are bent in a direction towards the slots 23, and the taps 24,24′ including the heads become aligned with the slots 23 and thus engage with the slots 23. The slots 23 may become wider below their opening so that the taps 24,24′ may bend back towards their original position relative to the storage unit 17 after the taps 24,24′ including head have passed the opening of the slots 23, i.e. the taps 24,24′ may snap-engage with the slots 23. Thus, the taps 24,24′ may show an elastic behaviour. The storage unit 17 cannot be easily removed from the reception layer 4. To remove the storage unit 17 from the reception layer 4, the user has to pull the storage unit 17. Thereby, the taps 24,24′ including their heads bend and thus align with the opening of the slots 23, whereby the engagement between the taps 24,24′ and the slots 23 disengages.

FIG. 4 shows one embodiment of the container 1 seen from below, where a reception layer 16 is connected to an inner part of the container 1. For similar parts, similar reference numbers have been used as in the previous Figs.

The first 20, second 20′, third 20″ and fourth releasable snap engagement 20″′ may each comprise two arms each comprising a protrusion 27,27′ at the ends and of a first 25, second 25′, third 25″ and fourth hole 25″′ in the bottom 26 of the container 1 through which the protrusions 27,27′ protrude. When the reception layer 16 is connected to the inner part of the container 1, the distance between the tips of the protrusion 27,27′ at the ends of the two arms is larger than the diameter of each of their respective holes 25,25′,25″,25″′. Thus, the reception layer 16 will not disconnect from the inner part of the container 1 unless the user presses the two arms for each of the snap engagements 20,20′,20″,20″′ together so that the distance between the tips of the protrusion 27,27′ at the ends of the two arms is smaller than the diameter of said holes 25,25′,25″,25″′.

1. A container, such as an assortment box, comprising a storage assembly, wherein said storage assembly is for storing contents inside said container, where said storage assembly comprises at least one storage unit and a reception layer fixated inside said container, wherein said at least one storage unit is adapted to be connected to said reception layer in a releasable manner by use of a first connection means, characterised in that said reception layer is fixated with an inner part of the container (1) in a releasable manner by use of a second connection means, where said first connection means comprises at least one releasable snap engagement and at least one protruding part and one recess part, and where a tap of the at least one releasable snap engagement and said at least one protruding part are arranged on and protruding from a lower surface of the storage unit (17), and the reception layer comprises symmetrically distributed recesses of the first connection means for receiving said tap and at least one protruding part.

2. A container according to claim 1 characterised in that said first connection means comprises at least one releasable snap engagement.

3. A container according to claim 1 characterised in that said first connection means comprises at least one protruding part and one recess part.

4. A container according to claim 3 characterised in that said storage unit comprises the at least one protruding part, and said reception layer comprises the at least one recess part adapted to receive the at least one protruding part.

5. A container according to claim 1 characterised in that the first connection means is arranged at the reception layer and at a lower surface of the at least one storage unit.

6. A container according to claim 1 characterised in that the reception layer is adapted to be fixated with an inner part of the container in a releasable manner by use of a second connection means.

7. A container according to claim 1 characterised in that a bottom of the container is the reception layer.

8. A container according to claim 1 characterised in that at least part of the first connection means is arranged symmetrically on the lower surface of the at least one storage unit relative to a plane which is parallel with and intersects the longitudinal axis of said at least one storage unit and which is orthogonal with at least one side of said at least one storage unit.

9. A container according to claim 1 characterised in that the reception layer is adapted to connect with more than one storage unit at a time.

10. A container according to claim 1 characterised in that the at least one storage unit is arranged adjacent to one or further storage units when connected with said reception layer.

11. A container according to claim 1 characterised in that the at least one storage unit comprises straight walls being orthogonal to the lower surface of the at least one storage unit.

12. A container according to claim 1 characterised in that a limited section of the reception layer does not comprise at least part of the first connection means.

13. A reception layer for a container according to claim 1, characterised in that said reception layer is adapted to connect to a container and to at least one storage unit in a releasable manner by use of connection means.

14. A storage unit for a container according to claim 1, characterised in that said storage unit comprises a bottom and at least one side part, said bottom and at least one side part defining an inner volume of said storage unit, and wherein said storage unit is adapted to connect to a reception layer in a releasable manner by use of a connection means.
